(19) United States
(12) Patent Application Publication
(10) Pub. No.: US 2005/0289172 A1
(43) Pub. Date: Dec. 29, 2005

(54) System and method for processing electronic documents

(75) Inventor: Georg Bauer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/531,602

(22) PCT Filed: Oct. 7, 2003
(86) PCT No.: PCT/IB03/04405

§ 371 Date: Apr. 14, 2005

(30) Foreign Application Priority Data
Oct. 19, 2002 (DE) 102 48 837.1

(51) Int. Cl. G06F 7/00

(52) U.S. Cl. 707/102

(57) ABSTRACT

A system and a method for processing electronic documents are described in which an input document D1 and reference data D2 are examined whether there is a content-based relation between the input document D1 and the reference data D2. For the case of a content-based relation, a type of linkage is selected from a number of predefined types of linkages in accordance with the type of content-based relation and a respective linkage between the documents is established. The invention makes it possible for the type of relation between two documents to be recognized automatically. For example, a document flow can be segmented in suitable manner and classified and also stored in an appropriately interlinked manner.

The invention relates to a system and a method for processing electronic documents as well as a program for implementing the method.

In view of the multitude of data available nowadays which can be retrieved for example via computer networks such as the Internet, systems and methods are ever more fallen back on that automatically process electronic documents in accordance with their content. In this respect, methods are known that classify a document in accordance with its content.

U.S. Pat. No. 5,983,246 describes a method and a device for processing documents. In a network environment ever new documents or new versions of documents are searched for and processed in that they are classified according to their content. The classification is carried out automatically in that similarities between the currently processed and already classified documents are utilized. In essence, a distinction value in the form of a word frequency table is examined to determine a measure for the matching of the documents.

It is an object of the invention to provide a system and a method by which the documents can be processed and additional information about the documents is automatically generated.

This object is achieved by a system as claimed in claim 1, a method as claimed in claim 11 and a program as claimed in claim 12 for executing the method. Dependent claims relate to advantageous embodiments of the invention.

According to the invention at least one input document is analyzed for its content-based relation with reference data. The reference data may, for example, be a second document. The reference data may also be a group (cluster) of documents or a representation thereof. On the basis of the analysis a decision is made whether there is a content-based relation. Subsequently, the sort of this relation is determined and attempts are made to assign this to a type. For this purpose a number of possible types of linkages are predefined i.e. kinds of content-based relations between two documents. If there is a respective content-based relation, the respective linkage between the documents will be established.

“Documents” are here meant to be understood as data which are available in electronic form. For example, text documents may be meant then. They may also be linkages of text and video information. Preferably, the processed documents have at least one text portion. Also, for example, audio or video data files may be processed, the text content then preferably occurring either in transcribed form or being generated during processing by a speech recognition system. Examples of data file formats for documents to be processed are HTML, or—more generally—XML documents. The documents may be of different types of contents. They may be, for example, individual messages. The documents may also be works of literature or scientific articles, interviews etc. Preferably the documents also comprise at least one data portion with additional information (meta data) for example source specification, date of creation etc.

Within the scope of the invention a number of linkage types are predefined. These linkage types correspond to content-based relations between two documents or between a document and a document cluster. Examples of linkage types between two documents A and B would be, for example, “document A is an interview about the event described in document B”, or “document A is a review of the book document B”. A content-based relation is a decisive factor here, which relation is determined by the type of linkage. Such linkage preferably has a fixed direction. An example for a cluster C would be given, for example, by a cluster of documents that all deal with a certain event. A possible type of linkage between the document A and the cluster C would then be, for example, “document A is a discussion about the event dealt with by cluster C”.

The invention thus goes beyond the mere establishing of similarity relations between two documents. The type of relation between two documents or a document and a cluster is recognized automatically. For example, a document flow can be suitably segmented and classified or extended by automatically generated meta data and be stored in a suitably interlinked version.

The system according to the invention includes input means, analysis means, selection means and output means. Preferably it is a device with one or more computers which are capable of entering documents and reference data for example from a memory or via a network interface. The analysis of the relation between the documents and reference data as well as the selection of a type of linkage may be carried out by a suitable program. The linkage found is output, for example, by displaying it on a screen, via a network interface or storage in a suitable permanent or temporary memory.

In accordance with a further embodiment of the invention keywords are searched for during the analysis of the documents, which keywords denote the type of the relation between the content of the input document and the reference data. Depending on the keywords found, the linkage is established i.e. the type of linkage is selected.

Examples of such keywords may be introductory words such as “now a comment on . . . ” for example, in the case of processing of news items. They are preferably linkages of a plurality of related keywords which are here referred to as key phrases.

During the processing of a document it can be classified, i.e. assigned to one from a number of predefined types of documents. For determining the type of content-based relation one may then fall back on the determined type of document.

A further embodiment of the invention provides that the input document comprises a text portion and a data portion. The text portion is the preferably processed content of the document. The data portion contains further information (meta data) about the document, for example, information about the type, origin and/or date of the document. Obviously, the document may comprise further portions, for example, graphics, video or audio contents. The meta data about the document and contained in the data portion may automatically be provided when the document is made. For example, if news items from a television station are received as documents, a source (name of the news station) and the transmit time can be registered automatically. For documents retrieved from the Internet the content provider may be registered and, as far as can be retrieved, further meta data (for example date of creation, name of the author etc.). Furthermore, meta data can be generated by additional processing steps. If, for example, documents are processed that were originally available as audio or video databases and whose text contents are generated, for example, by speech recognition, further information from the speech recognition can be processed as meta data. For this purpose, for example an identification of the respective speaker may take place. Such techniques are known to the expert in the field of speech recognition. The results of the speaker identification and also a regular change of speaker (which would point to the ‘interview’ type of document) may be registered, for example, in the data portion of the document. Similarly, the noise background may be evaluated to make a distinction between studio contributions and, for example, live reports (with background noise) and registered in the data portion.

According to another further embodiment of the invention a special database is accessed for the analysis of the content-based relation of the documents. In this database terms of the respective language are assigned to respective generic terms. This information used for terms occurring in either of the two documents may be used during the analysis of the content-based relation between the documents.

A further embodiment of the invention relates to the interlinked storage of documents in an electronic memory system in which documents are stored in a semantically interlinked fashion. For stored documents may be stored—when content-related documents are also stored—a linkage of the respective linkage type related to this document. Such a memory system may be built up by consecutive processing of the documents and be extended by new documents. When the memory system is accessed, a document can be accessed in a simple manner without additional analysis steps via content-related documents. Via the linkage type the access may be directed to certain types of content-based relations in a purpose-oriented way. The memory system may be part of the computer system according to the invention and comprise one or more storage media or electronic memories (RAM) and/or optical or magnetic data carriers. A plurality of storage media together may be accommodated in one appliance or distributed over a plurality of interconnected appliances, for example, via a network.

These and other aspects of the invention are apparent from and will be elucidated with reference to the embodiments described hereinafter.

In the drawings:

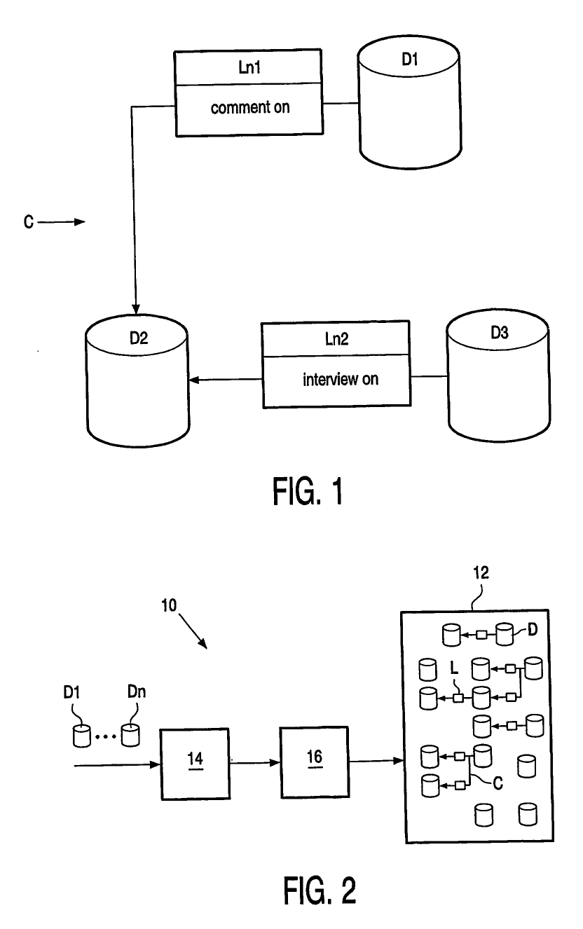

FIG. 1: shows in a symbolic representation linkages between three documents;

FIG. 2: in a symbolic representation elements of an information processing system.

FIG. 1 shows in a symbolic representation the three documents D1, D2 and D3.

In the present example the document D2 is a video data file containing information about a current event. The video data file is part of a message transmission and contains an audio comment on the event shown. The audio comment is available in transcribed form in document D2 or is generated by automatic speech recognition, respectively. The document D2 thus contains a video portion and a text portion. In addition, the document D2 contains a data portion in which information about the document is stored, among which the original transmission time of the article as well as the name of the sender.

The document D1 is in this case a newspaper comment on the current event which is reported on in D2. The document D1 is available in the form of an HTML page with the respective text. In addition to the text portion, D1 also contains a data portion in which the source (name of the newspaper) as well as the date of the publication are registered.

The document D3 is an interview about the same current event also D2 is about. The interview is available as an audio data file. Moreover, with the aid of automatic speech recognition the wording of the interview was converted into text form which is available for processing. This is also a data portion with information about the document. When the automatic speech recognition was carried out, a speaker was identified. The recognized sample of the regular change between two speakers (interview) was detected and stored in the data portion.

A system for processing the documents D1, D2 and D3 and for generating linkages is given by a data source which renders the documents available and by a computer which processes a program by which a content relation between two documents can be detected and a respective linkage between the documents can be established. For this purpose the program enters the documents and processes the text content of the documents as well as the data portion where appropriate. It is then first established whether there are content-related links between the documents and of which type these links are. The type of content-related link is assigned to a type of linkage from a predefined list of linkages. A linkage of the selected type of linkages between the documents is generated.

FIG. 1 shows a linkage Ln1 between the documents D1 and D2. The linkage Ln1 is of the type “comment on”. The linkage is set and points from document D1 to document D2. It thus indicates as content-related link between D1 and D2 that the content of D1 is a comment on the event depicted in D2.

Another example is the linkage Ln2 between the documents D3 and D2. The linkage is of the type “interview on event” and points from document D3 to document D2. The linkage Ln2 is generated by the program mentioned above after it was recognized that the content of D3 is an interview on the event depicted in document D2.

The documents D1, D2 and D3 shown in FIG. 1 with the linkages Ln1, Ln2 form a group of documents referred to here as cluster C. Such a cluster may comprise a large number of documents. The documents of the cluster are related as regards their contents in that they are about the same theme.

The linkages Ln1 and Ln2 shown in FIG. 1 between the documents D1, D2 and D3 are always linkages between individual documents. It is also possible, however, to define linkages between a new document to be analyzed and an already existing cluster C comprising a plurality of documents.

The processing of documents by the program is effected as follows:

First an input document is entered. During the processing, on the one hand the text content and, on the other hand a data portion is considered containing additional information about the document.

The input document is compared with reference data to establish whether there is a content-based relation. As explained above, the reference data may be a second document. Similarly, the reference data may also be a cluster of documents or a representation thereof, respectively.

If no content-based match between the input document and the reference data is found, the processing about this comparative pair is terminated. The input document may then be compared, for example, with further reference data.

If, on the other hand, a content-based relation is found, a further processing is made with the object of establishing the type of relation and generating a respective link. For this purpose, predefined key phrases are identified in the input document, which phrases show a reference to each other. The respective key phrases are assigned to types of linkages in a table.

Moreover, the information contained in the data portion of the input document is assessed. The results of the search for key phrases and the additional information from the data portion of the input document are assessed to select a type of linkage.

A linkage of the selected type of linkages is generated between the input document and the reference data and stored in a database.

For establishing whether there is a content-based relation between the input document and the reference data, techniques known to a man of skill in the art can be implemented. A known technique comprises an analysis of the text content by considering frequently recurring words in the text. If two documents are compared for example a vector of word frequencies of the n most frequent words in the two documents is established, where n is suitably selected. A vector distance may then be determined which may be regarded as a parameter for content-based relation between the documents. Such techniques are described, for example, in U.S. Pat. No. 5,983,246. In the articles “Text Categorization With Support Vector Machines: Learning with Many Relevant Features” 1998 by Thorsten Joachims, Proceedings of the ECML '98 (European Conference on Machine Learning) and “Improving text retrieval for the routing problem using latent semantic indexing” (1994) by David Hull, Proceedings of the SIGIR '94 (Special Interest Group On Information Retrieval) also such techniques are discussed. The contents of the cited documents are included here.

If the relation between a document and a cluster of documents is considered, this may be done as the sum of individual comparisons. For performance reasons, however, the document may also be compared with one or more representations of the cluster. Such representations condense common matters of the documents of the cluster. If, for example, the word frequency method defined above is worked with, a representation of a cluster comprises a list of terms recurring in the documents of the cluster.

In the step of selecting a suitable type of linkage mentioned above, for example, a table with an assignment of key phrases to types of linkages is used. The key phrases may be individual words. As a rule, however, they are linkages of keywords and further elements such as place names or names of persons. Hereinbelow is given as an example a Table containing a respective assignment:

| Key phrase | Associated type of linkage |
|---|---|
| Live preceding place in <place name> is | Live report |
| for us <name of person> | |
| In this respect a comment of | Comment |
| <name of person> | |

In addition to the key phrases mentioned above, information containing meta data can be processed into the input document. Such meta data may be contained in the data portion of the document or be generated by separate processing steps. For example, when the test portion is built up from an audio data file, in addition to known techniques of speech recognition, also the equally known techniques of speaker identification may be used to detect, for example, constant changes of speaker, which point to an interview.

The total amount of information recovered from the analysis of the key phrases and the additional meta data is evaluated with a suitable type of linkage as regards a match. The type of linkage having the highest score is selected.

In addition, during the analysis of the type of content-based relation between the documents, a special term database can be accessed. This database contains terms of the respective language used and assigns terms, on the one hand, to its higher-order generic terms and, on the other hand, to special terms contained therein. The word “tool” will thus be assigned, for example, to a generic term “matter” and, on the other hand, to a special term like “hammer”. Such databases are known. Furthermore, known databases of this type which are also referred to as thesaurus register synonyms and antonyms of terms as well as meronyms, holonyms, hyperonyms and hyponyms of terms.

Such a database may be used, on the one hand, for the analysis step of finding out whether there is a content-based relation between input document and reference data. If this examination is based on the comparison of frequently occurring words, for example instead of the approach of individual terms, groups of synonymous terms (synonyms) may be considered, so that different formulations of the same fact are recognized as content related.

On the other hand, such databases may also be used for establishing the type of content relation between two documents or between a document and a document cluster. For example, in a database in which there is assignment to special and generic terms, the terms occurring in a first document may be considered with respect to their position in the database (generic terms: general; special terms: special) and thus a suitable or numerical measure can be formed for the degree of specialization of the terms used. If, for example, it is found in two documents recognized as content related that a document largely mentions general generic terms, whereas the other document utilizes special vocabulary, conclusions may be drawn from this about the different strongly detailed treatment of this subject.

These findings can be used together with the meta data about the document and findings about detected key phrases to select a suitable type of linkage.

FIG. 2 shows in symbolized form a system 10 for document processing. The system 10 comprises a data memory 12 in which are stored, on the one hand, documents D and, on the other hand, linkages L between documents D. Cluster C is formed by documents associated to linkages.

The system 10 further comprises an analysis and decision unit 14 and a selection unit 16. The system 10 processes a flow of documents D1 . . . Dn which are supplied in a constant stream. This document flow may be read, for example, from a document database. The document flow D1 . . . Dn may also be the result of a program working as a web spider which fetches documents from the Internet in a constant flow. The data flow D1 . . . Dn may finally also be the result of a constant assessment or the result of the transmissions of various news stations.

The documents D1 . . . Dn are first of all checked by the analysis and decision unit 14 for a content-based relation to any of the individual documents D and document clusters C already stored in the data memory 12. If there is a content-based relation, its type is determined, as indicated above and a respective linkage L is established. The currently processed document and all the linkages L generated are stored in the data memory 12. In this manner a semantic network registering documents and specific relations of different types between these documents evolves in data memory 12. If for an input document no document D or cluster C having a content-based relation is found, the input document is stored separately and can form the core of a new reference cluster.

In a concrete embodiment the data memory 12 may be realized, for example, as an XML database. If the documents D can be fetched in a computer network such as the Internet under a known address (URL), instead of the storing of documents D in the data memory 12, also the respective URL may be stored.

1. A system for processing electronic documents, comprising:
input means for inputting at least an input document (D1) and reference data (D2),
analysis means (16) for analyzing the content of the input document (D1) as regards a content-based relation between the input document (D1) and the reference data (D2),
selection means for selecting a type of linkage from a number of predefined types of linkages, a type of linkage being selected that corresponds to the type of content-based relation between the input document (D1) and the reference data (D2),
and output means for outputting a linkage (L) of the selected type.

2. A system as claimed in claim 1, in which the linkage (L) comprises a linkage direction.

3. A system as claimed in claim 1, in which the reference data are a second document (D2).

4. A system as claimed in claim 1, in which the reference data are a representation for a group of content-related documents.

5. A system as claimed in claim 1, in which:
during the selection of the type of linkage keywords are searched for which denote the type of linkage between the content of the input document (D1) and the reference data (D2),
and a type of linkage is selected corresponding to the keywords found.

6. A system as claimed in claim 1, in which:
when the type of linkage is selected, the document (D) is assigned to one from a plurality of predefined types of documents,
and a type of linkage is selected in accordance with the type of document.

7. A system as claimed in claim 1, in which:
the input document (D1) comprises at least a text portion and a data portion,
the data portion containing information about the type and/or origin of the document.

8. A system as claimed in claim 6, in which the data portion of the input document (D1) is used to select the type of document.

9. A system as claimed in claim 1, in which the analysis means access a database in which terms are assigned to generic terms.

10. A system as claimed in claim 1, in which:
the input document (D1) and the established linkage (L) are stored in a memory system (12),
the memory system (12) being organized so that for documents stored therein there are linkages to other documents.

11. A method for processing documents in which:
at least one input document (D1) and reference data (D2) are processed,
the input document (D1) being analyzed with respect to its content and a decision being made whether there is a content-based relation between the input document (D1) and the reference data (D2),
for the case of a content-based relation a type of linkage being selected from a number of types of linkages in accordance with the type of content-based relation between the input document (D1) and the reference data (D2),
and a linkage of the selected type is established.

12. A program for implementing a method as claimed in claim 11.
